(19) United States
(12) Patent Application Publication
(10) Pub. No.: US 2025/0078475 A1
(43) Pub. Date: Mar. 6, 2025

(54) TRAINING APPARATUS, TRAINING METHOD, AND NON-TRANSITORY COMPUTER-READABLE STORAGE MEDIUM

(71) Applicant: KABUSHIKI KAISHA TOSHIBA, Tokyo (JP)

(72) Inventors: Shun HIRAO, Kawasaki Kanagawa (JP); Shuhei NITTA, Tokyo (JP)

(73) Assignee: KABUSHIKI KAISHA TOSHIBA, Tokyo (JP)

(21) Appl. No.: 18/760,028

(22) Filed: Jul. 1, 2024

(30) Foreign Application Priority Data
Sep. 5, 2023 (JP) 2023-143924

(51) Int. Cl. G06V 10/774; G06V 10/26; G06V 10/82; G06V 10/94; G06V 10/98; G06V 20/69

(52) U.S. Cl. CPC G06V 10/774; G06V 10/82; G06V 10/945; G06V 10/98; G06V 10/26; G06V 20/69; G06V 2201/03

(57) ABSTRACT

According to one embodiment, a training apparatus includes processing circuitry. The processing circuitry acquires a plurality of items of subject data and a plurality of items of incidental data corresponding to the plurality of items of subject data, calculates an importance of each of the plurality of items of subject data based on a distribution of the plurality of items of incidental data, determines, for each of the plurality of items of subject data, a number of items of training data according to the importance, and generate a plurality of items of training data corresponding to the determined number of items of training data, and iteratively trains a learning model on the plurality of items of training data for each of the plurality of items of subject data by unsupervised learning.

### CROSS-REFERENCE TO RELATED APPLICATION

This application is based upon and claims the benefit of priority from Japanese Patent Application No. 2023-143924, filed Sep. 5, 2023, the entire contents of which are incorporated herein by reference.

### FIELD

Embodiments described herein relate generally to a training apparatus, a training method, and a non-transitory computer-readable storage medium.

### BACKGROUND

Conventionally, a technique of performing unsupervised learning by segmenting a pathological image associated with prognostic information as incidental data into a plurality of patch images, classifying the patch images based on a relationship between the incidental data and feature vectors of the patch images obtained by the unsupervised learning, and presenting the patch images relating to the incidental data has been known.

In such a technique, the incidental information is not necessarily in a distribution preferable for unsupervised learning. For example, the learning efficiency may decrease in the case where incidental information with a small amount of data is of interest. Specifically, in the case where training is performed on pathological images, there are often cases where the disease is not advancing (or there are no diseases) as a whole. Even in a pathological image of an advancing disease, it is often the case that only a part is lesioned, and much of the rest is normal. Thus, a patch image group generated by segmenting a pathological image into patch images generally exhibits a normal image pattern, and extraction of a local abnormal pattern that is minor but needs to be given attention to raises the problem of an increase in time for training the model.

### BRIEF DESCRIPTION OF THE DRAWINGS

FIG. 1 is a block diagram illustrating a configuration of a training apparatus according to an embodiment.

FIG. 2 is a graph illustrating a relationship between a characteristic value and a probability density according to the embodiment.

FIG. 3 is a graph illustrating a relationship between a characteristic value and a number of images according to the embodiment.

FIG. 4 is a block diagram illustrating a specific configuration of a training unit shown in FIG. 1.

FIG. 5 is a block diagram illustrating a specific configuration of a loss calculation unit shown in FIG. 4.

FIG. 6 is a flowchart illustrating an operation of the training apparatus according to the embodiment.

FIG. 7 shows scatter charts in which feature vectors are visualized for each progression in training according to a conventional technique.

FIG. 8 shows scatter charts in which feature vectors are visualized for each progression in training according to the technique of the embodiment.

FIG. 9 shows an example of display data including scatter charts in which characteristic values are reflected according to a modification of the embodiment.

FIG. 10 shows an example of display data including a patch image and a scatter chart in which characteristic values are reflected, according to a modification of the embodiment.

FIG. 11 shows an example of display data including a patch image group and a scatter chart in which feature cluster labels are reflected, according to a modification of the embodiment.

FIG. 12 is a block diagram illustrating a hardware configuration of a computer according to the embodiment.

### DETAILED DESCRIPTION

In general, according to one embodiment, a training apparatus includes processing circuitry. The processing circuitry acquires a plurality of items of subject data and a plurality of items of incidental data corresponding to the plurality of items of subject data, calculates an importance of each of the plurality of items of subject data based on a distribution of the plurality of items of incidental data, determines, for each of the plurality of items of subject data, a number of items of training data according to the importance, and generate a plurality of items of training data corresponding to the determined number of items of training data, and iteratively trains a learning model on the plurality of items of training data for each of the plurality of items of subject data by unsupervised learning.

Hereinafter, an embodiment of a training apparatus will be described in detail with reference to the accompanying drawings. In the embodiment, a machine learning model which clusters an image (hereinafter referred to as an “SEM image”) obtained by photographing a cross section of a product (e.g., a substrate obtained by sintering alumina) with a scanning electron microscope (SEM), etc. by unsupervised learning will be described as an example. It is assumed, for example, that a neural network is employed for machine learning. That is, the learning model of the embodiment is a neural network model.

### Embodiment

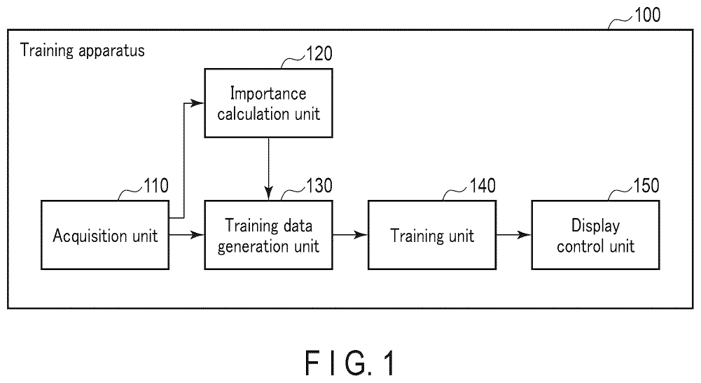

FIG. 1 is a block diagram illustrating a configuration of a training apparatus 100 according to the embodiment. The training apparatus 100 is a computer for generating a trained model by training a machine learning model by unsupervised learning. The training apparatus 100 includes an acquisition unit 110, an importance calculation unit 120, a training data generation unit 130, a training unit 140 140, and a display control unit 150.

The acquisition unit 110 acquires a plurality of items of subject data and a plurality of items of incidental data respectively corresponding to the plurality of items of subject data. The acquisition unit 110 outputs the plurality of items of incidental data to the importance calculation unit 120, and outputs the plurality of items of subject data to the training data generation unit 130.

The subject data is, for example, a plurality of SEM images. The incidental data is, for example, continuous values (hereinafter referred to as “characteristic values”) representing characteristics of a product relating to the SEM images. In a specific example of the embodiment, it is assumed that the subject data is SEM images, and that the incidental data is characteristic values.

The importance calculation unit 120 receives, from the acquisition unit 110, a plurality of items of incidental data. The importance calculation unit 120 calculates an importance based on a plurality of items of incidental data. Specifically, the importance calculation unit 120 calculates an importance of each of a plurality of items of subject data based on a distribution of the plurality of items of incidental data. The importance calculation unit 120 outputs the importance of each of the plurality of items of subject data to the training data generation unit 130.

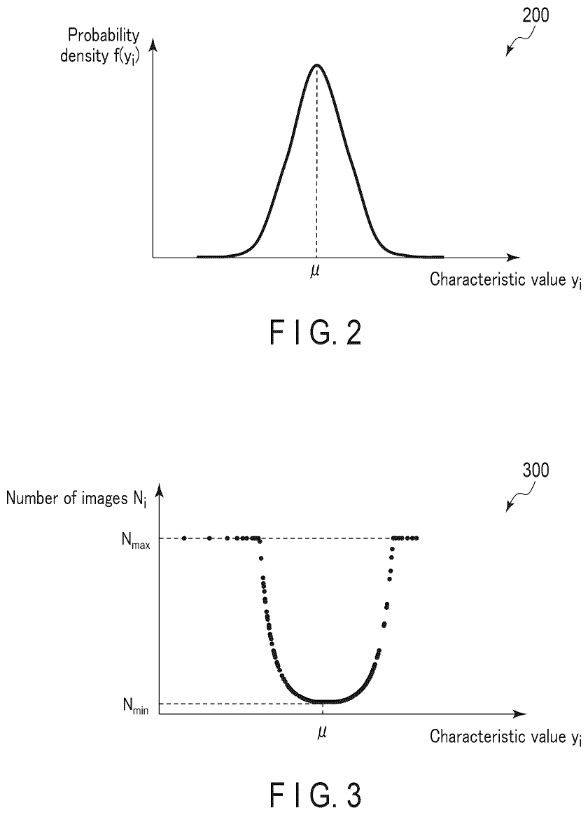

If the characteristic values are represented by a probability distribution with a variance σ² that has its peak at a mean μ, the above distribution will be a normal distribution. Hereinafter, a relationship between a characteristic value yᵢ and a probability density f(yᵢ) will be described with reference to FIG. 2. The characteristic value yᵢ denotes a characteristic value of an i-th SEM image included in a plurality of items of subject data (a plurality of SEM images).

FIG. 2 is a graph 200 illustrating a relationship between a characteristic value yᵢ and a probability density f(yᵢ). In the graph 200, the horizontal axis represents a characteristic value yᵢ and the vertical axis represents a probability density f(yᵢ). In the graph 200, a normal distribution that has its peak at a mean μ is shown. It can be seen, from the graph 200, that the probability density f(yᵢ) becomes smaller for a characteristic value yᵢ farther from the mean u. Here, the probability density f(yᵢ) is proportional to the number of SEM images each having a characteristic value yᵢ. That is, it can be seen that the number of SEM images corresponding to the characteristic value yᵢ farther from the mean μ is small.

Accordingly, it is desirable that a higher importance be placed on an SEM image corresponding to a characteristic value yᵢ farther from the mean μ (in other words, with a larger difference from the mean u). Thus, for the calculation of the importance, the following formula (1), for example, is used.

$${I}_{i} = \frac{1}{\frac{1}{\sqrt{2 π} σ} exp ( - \frac{{( {y}_{i} - μ )}^{2}}{2 {σ}^{2}} )} = \frac{1}{f ( {y}_{i} )} \qquad ( 1 )$$

In the formula (1), Iᵢ represents an importance of an i-th SEM image corresponding to the characteristic value yᵢ. As described above, a probability density function of a normal distribution takes a greatest value at the mean u, and takes a smaller value as the characteristic value yᵢ becomes farther from the mean μ. Accordingly, in the formula (1), the importance Iᵢ is set to take a greater value as the characteristic value yᵢ becomes farther from the mean u.

In calculation of the importance, it is important to grasp a distribution of a plurality of items of data (e.g., characteristic values), and to assign an importance according to the distribution to each item of data. Accordingly, the plurality of items of incidental data, for which calculation is to be performed, need not have a normal distribution. For example, the plurality of items of incidental data may be either in a single-peaked distribution as represented by a normal distribution, or in a non-single-peaked distribution.

In the case of calculation of the importance using the formula (1), a mean μ and a variance σ² need not be taken into consideration for all of the characteristic values. If some of the characteristic values include an extreme outlier, there may be a case where a correct mean u cannot be estimated. Accordingly, a median, for example, may be used instead of the mean. Also, a range of characteristic values for which calculation is to be performed may be limited, using, for example, a quantile and a standard deviation.

In other words, the importance calculation unit 120 may calculate an importance of incidental data corresponding to subject data that appears infrequently to be high. Specifically, the importance may be calculated so as to be inversely proportional to the frequency of classification of a plurality of items of incidental data. Moreover, the importance calculation unit 120 may calculate an importance of an item of incidental data farther from a mean or a median of the distribution of the plurality of items of incidental data to be higher. Furthermore, the importance calculation unit 120 may calculate the importance to be lower for incidental data closer to a mean or a median of the plurality of items of incidental data.

The training data generation unit 130 receives, from the acquisition unit 110, the plurality of items of subject data, and receives, from the importance calculation unit 120, an importance of each of the plurality of items of subject data. The training data generation unit 130 determines, for each of the plurality of items of subject data, a number of items of training data according to the importance, and generates a plurality of items of training data corresponding to the determined number of items of training data. The training data generation unit 130 outputs, to the training unit 140, a plurality of items of training data for each of the plurality of items of subject data.

The training data is, for example, a plurality of patch images corresponding to some regions in an SEM image. If the training data is a plurality of patch images, the number of items of training data is equal to the number of patch images selected from an SEM image. It is desirable that the training data generation unit 130 extract (generate) patch images in such a manner that corresponding regions in the SEM image do not overlap one another. This relates to contrastive learning, which is part of unsupervised learning, since contrastive learning is performed in such a manner that each of a plurality of items of training data corresponds to a single class. If different patch images corresponding to overlapping regions in the SEM image are used, since image features common to different patch images will appear, which is contradictory to the purpose of contrastive learning, training of the learning model may be adversely affected. In other words, if a learning model is trained by contrastive learning in the training unit 140, the training data generation unit 130 generates a plurality of items of training data in such a manner that corresponding items of partial data in subject data do not overlap one another.

Next, a specific method of determining the number of items of training data will be described. First, a maximum number of items of training data and a minimum number of items of training data will be described. The maximum number of items of training data is determined by, for example, a relationship between a size of an SEM image and a size of each patch image. Assuming, for example, that an SEM image is in a size of 1280×960 and each item of training data is in a size (input size) of 64×64, 300 (=20 columns×15 lines) items of training data will be obtained by scanning (e.g., raster-scanning) the SEM image in such a manner that corresponding regions in the SEM image do not overlap one another. In this case, the maximum number of items of training data is 300. Also, the minimum number of items of training data may be set to a given value to secure a sufficiently large number of items of training data for a single SEM image.

In view of the above, the number of items of training data is determined using, for example, the following formula (2):

$${N}_{i} = min ( {N}_{max} , max ( {N}_{min} , {aI}_{i} ) ) \qquad ( 2 )$$

In the formula (2), “Nᵢ” denotes the number of images (number of extraction images) corresponding to the characteristic value yᵢ, “min(A, B)” denotes a function of selecting a smaller value between A and B, “max(A, B)” denotes a function of selecting a larger value between A and B, “Nₘₐₓ” denotes a maximum number (upper-limit value), “Nₘᵢₙ” denotes a minimum number (lower-limit value), and “a” denotes a coefficient. The coefficient a is set in such a manner that aIᵢ increases with an increase in an importance Iᵢ. Note that Nₘₐₓ, Nₘᵢₙ, and a are hyperparameters. Hereinafter, a relationship between the characteristic value yᵢ and the number of images Nᵢ in the formula (2) will be described with reference to FIG. 3.

FIG. 3 is a graph 300 illustrating a relationship between a characteristic value yᵢ and a number of images Nᵢ. In the graph 300, the horizontal axis represents the characteristic value yᵢ and the vertical axis represents the number of images Nᵢ. It can be seen, from the graph 300, that the number of images Nᵢ is clipped at the minimum value (lower-limit value) Nₘᵢₙ for a characteristic value yᵢ close to the mean u, increases as characteristic value yᵢ becomes farther from the mean u, and is clipped at the maximum value (upper-limit value) Nₘₐₓ for a characteristic value yᵢ exceeding a certain value or falling below another certain value.

An example will be shown using specific numerical values. Assuming that Nₘₐₓ=300 and Nₘᵢₙ=10 and the number of SEM images is 365, the number of items of training data to be generated for all the SEM images (Nₘₐₓ) will be 109,500 (=300×365). On the other hand, if the formula (2) is taken into consideration, the number of items of training data becomes 27,252. Since the training time according to the training technique used in the training unit 140 (SimCLR+FD training, to be described later) is substantially proportional to the number of items of training data, it is possible, with the technique of the present embodiment, to complete processing (training) in approximately ¼ of time (=27,252/109, 500) compared to the conventional technique that does not take the formula (2) into consideration.

In other words, the training data generation unit 130 may determine the number of items of training data to be larger for an item of subject data with a higher importance. Also, the training data generation unit 130 may determine a smaller number as the number of items of training data for subject data with a lower importance.

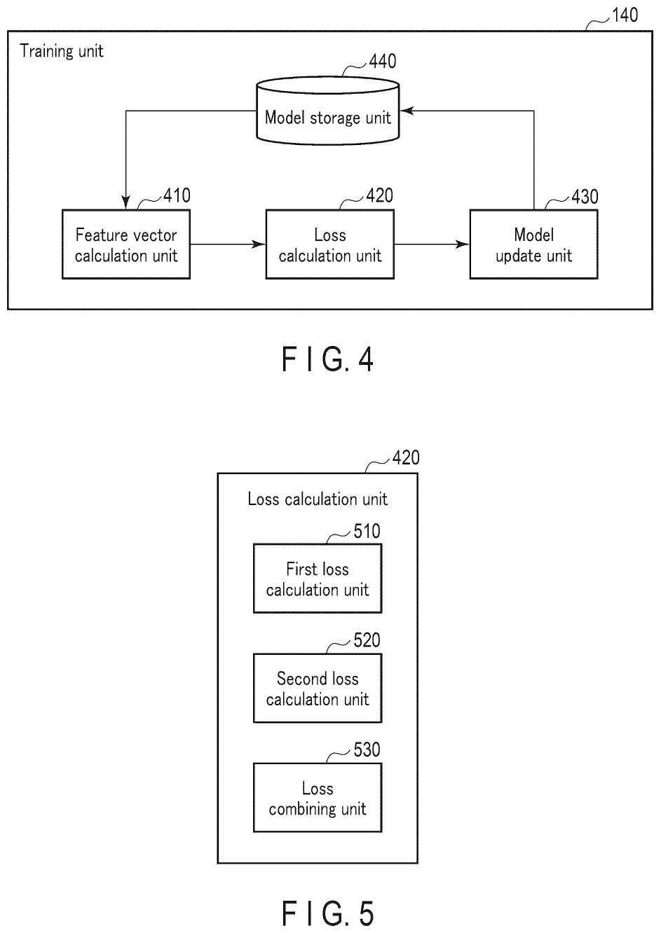

The training unit 140 receives, from the training data generation unit 130, a plurality of items of training data for each of a plurality of items of subject data. The training unit 140 iteratively trains a learning model on a plurality of items of training data for each of a plurality of items of subject data by unsupervised learning. The training unit 140 outputs the learning model for which training has been completed as a trained model. The training unit 140 outputs, to the display control unit 150, feature vectors of the respective items of training data, calculated at the time of training, for each of a plurality of items of subject data. A specific configuration of the training unit 140 will be described with reference to FIG. 4.

FIG. 4 is a block diagram illustrating a specific configuration of the training unit 140. The training unit 140 includes a feature vector calculation unit 410, a loss calculation unit 420, a model update unit 430, and a model storage unit 440. Hereinafter, one of the plurality of items of subject data will be described, and the term “each of the plurality of items of subject data” may be omitted. It is assumed that, in the training unit 140, a similar process is performed for all of the items of subject data.

The feature vector calculation unit 410 calculates feature vectors based on the training data. Specifically, the feature vector calculation unit 410 takes, as an input, training data for a model stored in the model storage unit 440, and outputs (calculates) a feature vector. The feature vector calculation unit 410 outputs the feature vector to the loss calculation unit 420.

In the present embodiment, the feature vector is calculated using data augmentation, which is employed for improving the learning precision of self-supervised learning. Example techniques of data augmentation of a patch image used in the present embodiment include brightness alteration, contrast alteration, Gaussian noise addition, inversion, and rotation. As a learning model used for feature vector calculation, a deep neural network (DNN) model that takes training data (a patch image) as an input and outputs a feature vector is used. For such a DNN, architecture parameters such as the number of layers and the number of channels are suitably set. For the DNN model architecture, a suitable model architecture (e.g., ResNet, MobileNet, and EfficientNet) may be used.

The feature vector calculation unit 410 may output a feature vector output from an output layer of the DNN, or an output from an intermediate layer several layers before the output layer may be configured as a feature vector. In the present embodiment, the feature vector is, for example, a 128-dimensional vector data output from the output layer of the DNN.

The loss calculation unit 420 receives the feature vector from the feature vector calculation unit 410. The loss calculation unit 420 calculates a loss using the feature vector. The loss calculation unit 420 outputs the loss to the model update unit 430. A specific configuration of the loss calculation unit 420 will be described with reference to FIG. 5.

FIG. 5 is a block diagram illustrating a specific configuration of the loss calculation unit 420. The loss calculation unit 420 includes a first loss calculation unit 510, a second loss calculation unit 520, and a loss combining unit 530.

The first loss calculation unit 510 calculates a first loss using, for example, SimCLR (a simple framework for contrastive learning of visual representations), which is a technique of unsupervised learning. Using SimCLR, the first loss L₁ can be obtained by the following formulas (3) and (4):

$$ℓ ( i , j ) = - log \frac{exp ( s i m ( {z}_{l} . {z}_{j} ) / τ )}{{Σ}_{k = 1}^{2 N} {1}_{[ k \neq i ]} exp ( s i m ( {z}_{i} , {z}_{k} ) / τ )} \qquad ( 3 )$$

$${L}_{1} = \frac{1}{2 N} {\sum }_{k = 1}^{N} [ ℓ ( 2 k - 1 , 2 k ) + ℓ ( 2 k , 2 k - 1 ) ] \qquad ( 4 )$$

In the formula (3), “N” denotes a number of items of training data, and “i” and “j” denote sequential numbers of two types of samples augmented by identical training data. Since two types of samples obtained from a single item of training data by data augmentation are used in SimCLR, the total number of samples is 2N.

Moreover, “1_{[k≠i]}” denotes a function that returns 1 if k≠1 and returns 0 if k=i, and “sim(A, B)” denotes a sim function (e.g., a cosine function) that outputs a greater numerical value as a degree of similarity between A and B increases. Furthermore, “z” denotes an output vector (a feature vector) of the DNN, subscripts (e.g., i, j, and k) of “z” denote sequential numbers of the training data, and “t” denotes a temperature parameter relating to the first loss. The temperature parameter t is configured to adjust a sensitivity of a numerical value output from the sim function, and is set in such a manner that the sensitivity increases as the value of the temperature parameter t decreases, and the sensitivity decreases as the value of the temperature parameter t increases. The temperature parameter t may be referred to as a “first temperature parameter”.

In other words, the first loss calculation unit 510 (or the loss calculation unit 420) calculates a loss using a technique (e.g., SimCLR) that yields a smaller loss as an error between a first feature vector and a second feature vector obtained from different items of subject data increases. Such a technique includes a temperature parameter for controlling a sensitivity of an error between the first feature vector and the second feature vector.

The second loss calculation unit 520 calculates the second loss using, for example, feature decorrelation (FD), which is a technique of unsupervised learning. Using FD, the second loss L₂ can be obtained by the following formula (5):

$${L}_{2} = {\sum }_{l = 1}^{d} ( - {{f}_{l}}^{T} {f}_{l} / {τ}_{2} + log {\sum }_{m}^{d} exp ( {{f}_{m}}^{T} {f}_{l} / {τ}_{2} ) ) \qquad ( 5 )$$

In the formula (5), “f” denotes a set of output vectors (feature vectors) of the DNN, and subscripts (e.g., “1” and “m”) of “f” denote indexes of elements of the feature vectors. For example, “fₗ” is an N-dimensional (or 2N-dimensional) vector in which l-th elements of the feature vectors are arrayed.

Also, “T” denotes transposition, and “τ₂” denotes a temperature parameter relating to the second loss. The temperature parameter τ₂ is configured to adjust a sensitivity of a numerical value calculated by an inner product of fₗ and a transposed matrix of fₗ and an inner product of fₗ and a transposed matrix of fₘ, and is set in such a manner that the sensitivity increases as the value of the temperature parameter 12 decreases, and the sensitivity decreases as the value of the temperature parameter τ₂ increases. The temperature parameter 12 may be referred to as a “second temperature parameter”.

The loss combining unit 530 calculates a combined loss (combinatorial loss) based on the first loss and the second loss. The combined loss L_{C} can be obtained by, for example, the following formula (6):

$${L}_{C} = {L}_{1} + λ {L}_{2} \qquad ( 6 )$$

In the formula (6), “A” denotes a hyperparameter, and is configured to adjust a ratio of influence between the first loss L1 and the second loss L₂. In the present embodiment, a training technique for minimizing the combined loss L_{C} will be referred to as “SimCLR+FD training”.

The model update unit 430 receives a loss from the loss calculation unit 420. The model update unit 430 updates the learning model using the loss. The model update unit 430 outputs parameters of the updated learning model to the model storage unit 440.

Specifically, the model update unit 430 applies optimization parameters based on the loss to the learning model to update parameters of the learning model. Examples of the optimization parameters include a type of an optimizer (e.g., momentum stochastic gradient descent (SGD), Adaptive Moment Estimation (Adam), etc.), a learning rate (or a learning rate schedule), the number of times of updating (the number of times of iterative training), a number of mini-batches (mini-batch size), and an intensity of Weight Decay.

The model storage unit 440 receives parameters for the learning model from the model update unit 430. The model storage unit 440 updates the learning model based on the received parameters, and stores the updated learning model.

The training unit 140 may determine whether or not to terminate iterative training based on a termination condition. Examples of the termination condition include whether or not a predetermined number of epochs (e.g., 4000 epochs) has been reached.

The display control unit 150 receives, from the training unit 140, feature vectors of the respective items of training data for the respective items of subject data. The display control unit 150 causes a correlation chart in which the feature vectors are expressed by multiple different components to be displayed. The display control unit 150 outputs display data including the correlation chart to a display, etc.

Specifically, the display control unit 150 transforms the 128-dimensional feature vectors into a two-dimensional or three-dimensional distribution (correlation chart) using a dimensionality reduction technique. Such a correlation chart is, for example, a scatter chart in which the feature vectors are expressed by points. Dimensionality reduction techniques include principal component analysis (PCA), t-distributed stochastic neighbor embedding (t-SNE), and uniform manifold approximation and projection (UMAP).

The training apparatus 100 may include a memory and a processor. The memory stores, for example, various programs (e.g., training programs) relating to the operation of the training apparatus 100. By executing various programs stored in the memory, the processor implements various functions of the acquisition unit 110, the importance calculation unit 120, the training data generation unit 130, the training unit 140, and the display control unit 150.

The training apparatus 100 need not be configured of a physically single computer, and may be configured of a computer system (training system) including a plurality of computers that can be communicatively connected with one another via a wired connection or a network line, etc. Assignment of a series of processes of the present embodiment to the plurality of processors mounted on the plurality of computers may be suitably set. All the processors may be configured to execute all the processes in parallel, or one or more processors may be assigned with a particular process, such that the series of processes of the present embodiment are executed by the computer system as a whole. Typically, the function of the training unit 140 according to the embodiment may be played by an external calculator.

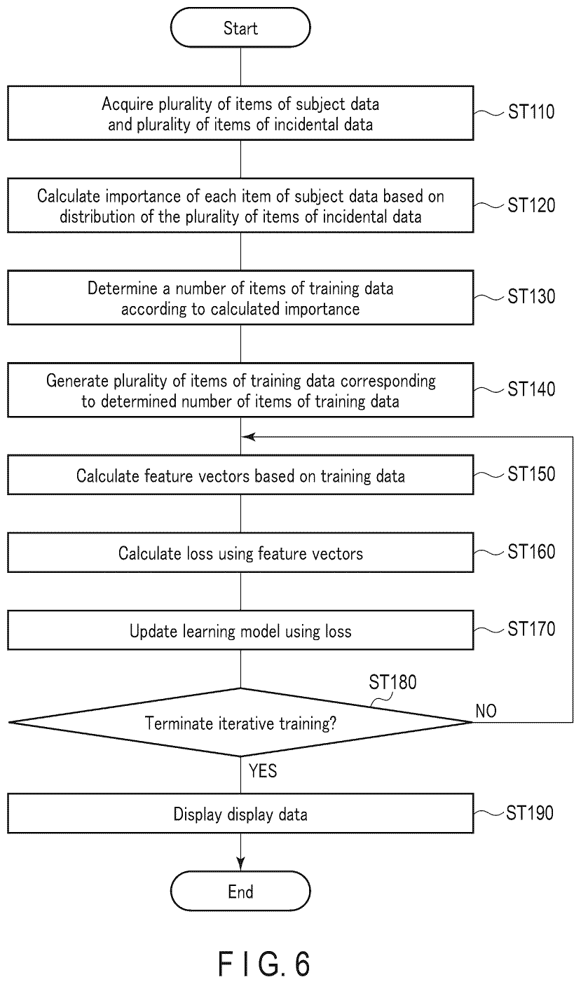

The configuration of the training apparatus 100 according to the embodiment has been described above. Next, the operation of the training apparatus 100 according to the embodiment will be described with reference to the flowchart of FIG. 6.

FIG. 6 is a flowchart illustrating an operation of the training apparatus 100 according to the embodiment. The processing of the flowchart in FIG. 6 is started by execution of a training program by the user.

### (Step ST110)

Upon execution of the training program by the training apparatus 100, the acquisition unit 110 acquires a plurality of items of subject data and a plurality of items of incidental data. Specifically, the acquisition unit 110 acquires a plurality of SEM images and a plurality of characteristic values.

### (Step ST120)

After the acquisition unit 110 has acquired a plurality of items of subject data and a plurality of items of incidental data, the importance calculation unit 120 calculates an importance of each item of the subject data based on a distribution of the plurality of items of incidental data. Specifically, the importance calculation unit 120 calculates an importance of each of the plurality of SEM images based on a normal distribution of the plurality of characteristic values.

### (Step ST130)

After the importance calculation unit 120 has calculated the importance, the training data generation unit 130 determines a number of items of training data according to the calculated importance. Specifically, the training data generation unit 130 determines a small number as the number of patch images for an SEM image with a low importance, and determines a large number as the number of patch images for an SEM image with a high importance.

### (Step ST140)

After determining the number of items of training data, the training data generation unit 130 generates a plurality of items of training data corresponding to the determined number of items of training data. Specifically, the training data generation unit 130 extracts a number of patch images determined according to the importance for each of the plurality of SEM images.

### (Step ST150)

After the training data generation unit 130 has generated the plurality of items of training data, the feature vector calculation unit 410 calculates feature vectors based on the training data. Specifically, the feature vector calculation unit 410 calculates, for each of the plurality of SEM images, feature vectors for the respective patch images extracted from each of the plurality of SEM images.

### (Step ST160)

After the feature vector calculation unit 410 has calculated the feature vectors, the loss calculation unit 420 calculates a loss using the feature vectors.

### (Step ST170)

After the loss calculation unit 420 has calculated the loss, the model update unit 430 updates a learning model using the loss.

More precisely, the processing from step ST150 to step ST170 is repeated for all of the plurality of items of training data generated from a plurality of items of subject data, thereby performing “iterative training”. A single cycle of processing for all the items of the training data will be referred to as an “epoch”.

### (Step ST180)

After a cycle of processing for all the items of training data, the training unit 140 determines whether or not to terminate the iterative training. For this determination, a predetermined number of epochs (e.g., 4000 epochs) is used as a termination condition. If it is determined to not terminate the iterative training, the processing returns to step ST150. If it is determined to terminate the iterative training, the processing advances to step ST190.

### (Step ST190)

After the training unit 140 has determined to terminate iterative training, the display control unit 150 causes display data containing a correlation chart based on feature vectors generated using a learning model at the time of termination of the iterative training to be displayed. After step ST190, the processing of the flowchart in FIG. 6 is terminated.

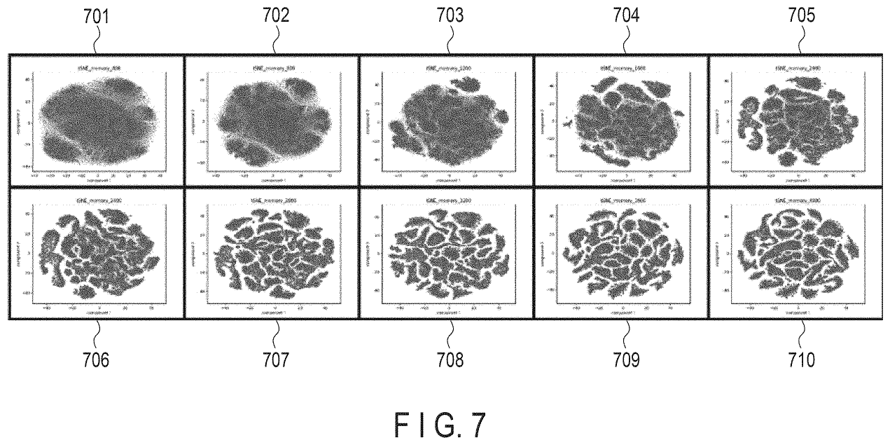

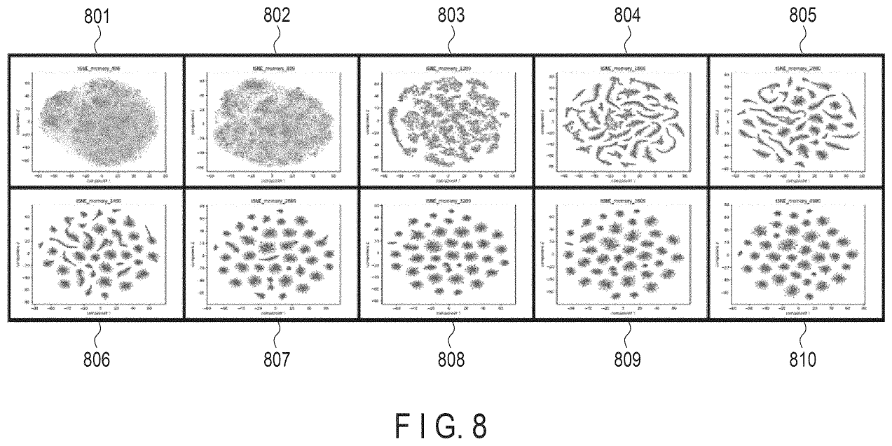

The operation of the training apparatus according to the embodiment has been described above. Next, a comparison between a conventional technique and a technique of the embodiment will be described using the scatter charts shown in FIGS. 7 and 8. It is assumed that, in the conventional technique, the same number of items of training data is uniquely generated from each of the plurality of items of subject data, and that, in the technique of the embodiment, a number of items of training data determined according to the importance is generated from each of a plurality of items of subject data.

FIG. 7 shows scatter charts in which feature vectors are visualized for each progression in training according to a conventional technique. FIG. 7 shows scatter charts 701 to 710 in which feature vectors are visualized every 400 epochs. Specifically, the scatter chart 701 shows a distribution of feature vectors at the end of the 400th epoch, the scatter chart 702 shows a distribution of feature vectors at the end of the 800th epoch, the scatter chart 703 shows a distribution of feature vectors at the end of the 1200th epoch, the scatter chart 704 shows a distribution of feature vectors at the end of the 1600th epoch, the scatter chart 705 shows a distribution of feature vectors at the end of the 2000th epoch, the scatter chart 706 shows a distribution of feature vectors at the end of the 2400th epoch, the scatter chart 707 shows a distribution of feature vectors at the end of the 2800th epoch, the scatter chart 708 shows a distribution of feature vectors at the end of the 3200th epoch, the scatter chart 709 shows a distribution of feature vectors at the end of the 3600th epoch, and the scatter chart 710 shows a distribution of feature vectors at the end of the 4000th epoch.

FIG. 8 shows scatter charts in which feature vectors are visualized for each progression in training according to the technique of the embodiment. FIG. 8 shows scatter charts 801 to 810 in which feature vectors are visualized for every 400 epochs, similarly to FIG. 7.

The number of sample points on the scatter charts shown in FIGS. 7 and 8 differ because of the difference in the number of items of training data corresponding to the feature vectors. For example, the number of items of training data according to the conventional technique in FIG. 7 is 109,500, and the number of items of training data according to the technique of the present embodiment in FIG. 8 is 27,252, as described above.

In the conventional technique of FIG. 7, the separation of clusters near the center as shown in the scatter chart 710 at the end of the 4000th epoch cannot be seen in the scatter chart 705 at the end of the 2000th epoch. That is, it can be construed that, in the conventional technique, 2000 epochs of training are insufficient.

On the other hand, in the technique of the embodiment shown in FIG. 8, the degree of separation between clusters in the distribution of the scatter chart 805 at the end of the 2000th epoch and that in the distribution of the scatter chart 810 at the end of the 4000th epoch are similar. That is, it can be construed that, in the technique of the embodiment, 2000 epochs of training are sufficient.

Thus, according to the technique of the embodiment, it is possible to terminate training with half of the number of epochs compared to the conventional technique of uniquely generating the same number of items of training data from each of a plurality of items of subject data. Also, as described above, according to the technique of the embodiment, it is possible to complete 1-epoch training in approximately ¼ of the time compared to the conventional technique, thereby completing the training in approximately ⅛ of the time in total. That is, the technique of the embodiment makes a great improvement in learning efficiency compared to the conventional technique.

As described above, the training apparatus according to the embodiment acquires a plurality of items of subject data and a plurality of items of incidental data corresponding to the plurality of items of subject data, calculates, based on a distribution of a plurality of items of incidental data, an importance of each of the plurality of items of subject data, determines, for each of the plurality of items of subject data, a number of items of training data according to the calculated importance, generates a plurality of items of training data corresponding to the determined number of items of training data, and iteratively trains a learning model on the plurality of items of training data for each of the plurality of items of subject data by unsupervised learning.

Accordingly, the training apparatus according to the embodiment is capable of efficiently training a model by varying the number of items of training data generated from subject data according to the importance.

### Modification 1

In the above-described embodiment, a case has been described where a specific method of generating a plurality of items of training data from subject data in the training data generation unit 130 has not been particularly defined. The training data generation unit 130 according to Modification 1 may employ a method of generating training data to be described below. Variations in the method of generating training data include: (1) in-advance segmentation; (2) dynamic generation; (3) coordinate acquisition; (4) employment of decimal coordinates; and (5) alternation in extraction density.

The generation method (1) is a method of segmenting training data (an SEM image) based on an upper-limit value in advance. For example, the training data generation unit 130 may segment all the SEM images into an upper-limit number of patch images in advance, and select patch images corresponding to an extraction number from the segmented SEM images. Alternatively, the training data generation unit 130 may extract patch images based on a probability proportional to the importance, without calculating the extraction number. If patch images are extracted based on a probability proportional to the importance, the training data generation unit 130 extracts, for example, a number of patch images corresponding to the maximum value of importance based on which segmentation into the patch images has been performed.

The generation method (2) is a method of dynamically generating patch images without performing in-advance segmentation. For example, the training data generation unit 130 may generate a number of patch images corresponding to an extraction number every time an SEM image is processed, in such a manner that there will be no overlap between regions.

The generation method (3) is a method of acquiring a data format of patch images as coordinates on an SEM image. For example, the training data generation unit 130 may acquire two-dimensional coordinates on an SEM image corresponding to regions of patch images. As the two-dimensional coordinates, for example, either coordinates of four points corresponding to vertexes of each patch image, or coordinates of a number of points smaller than four according to a predetermined rule may be acquired. Since the size of the patch image is determined, the predetermined rule is, for example, that coordinates at a position of at least one (e.g., the upper-left point) of the four points of the patch image are fixedly acquired, or that coordinates of a single point at the center (central gravity) of the patch image are acquired. If patch images are expressed by coordinates, the training unit 140 performs training by referring to corresponding regions in an SEM image. Also, since patch images are not generated, the training apparatus 100 need not hold patch images for training.

The generation method (4) is a method of acquiring patch images using decimal coordinates. For example, the training data generation unit 130 may extract patch images from an SEM image using decimal coordinates. Through the extraction using decimal coordinates, the number of combinations of positions of patch images dramatically increases, thus substantially eliminating the occurrence of patch images that appear completely the same, which is more preferable for unsupervised learning such as SimCLR. The values (pixel values) of decimal coordinates are acquired by filtering out pixel values of integral coordinates in the periphery of decimal coordinates.

The generation method (5) is a method of changing the density of the number of patch images to be extracted according to the region in an SEM image. For example, the training data generation unit 130 may be configured to increase a density of the number of patch images to be extracted at the center of an SEM image or in a particular region of interest, and to decrease the density in the periphery of the SEM image.

Also, the training data generation unit 130 may generate training data based on values of pixel positions and an edge direction of an SEM image.

### Modification 2

In the above-described embodiment, calculation resources for training a learning model have not been particularly limited; however, the configuration is not limited thereto. For example, in Modification 2, the total number of items of training data may be determined in consideration of calculation resources. As the calculation resources, (1) an occupation time of the calculator and (2) specifications of the calculator may be assumed.

The assumption (1) is training of a model that employs a calculator of a pay-per-use service. There may be a case where, for example, the occupation time of the calculator is determined according to the usage amount of the pay-per-use service. Accordingly, the training apparatus 100 may adjust values of hyperparameters relating to the number of patch images and adjust the number of items of training data based on the total amount of time of operation of the calculator determined based on budget. This is effective not only for a pay-per-use service but also for cases where the occupancy time of the calculator is determined.

The assumption (2) is training of a model that takes the specifications of the calculator into consideration. There may be a case where, for example, the operation rate of the entire calculator is affected by processing of generating training data. For example, since a memory access during training depends on the number of items of training data, an excessive memory access may possibly decrease the operation rate of the GPU of the calculator. Accordingly, based on the specifications of the calculator, the training apparatus 100 may adjust values of hyperparameters relating to the number of patch images and the number of items of training data.

In other words, the acquisition unit 110 may acquire calculation resource information (e.g., an occupation time and a memory amount of the calculator). The importance calculation unit 120 may change the method of calculating an importance according to the calculation resource information. The training data generation unit 130 may adjust the number of items of training data based on the calculation resource information.

### Modification 3

In the above-described embodiment, a case has been described where characteristic values configured of continuous values are used as a specific example of the incidental data; however, the configuration is not limited thereto. In Modification 3, for example, the incidental data may be characteristic values configured of categorical variables. Such a categorical variable may be, for example, either a dichotomous categorical variable that takes on two values or a polytomous categorical variable that takes on three or more values. A dichotomous categorical variable is, for example, on a nominal scale for determining whether a product is defective or non-defective. If the characteristic values are categorical variables, the importance may be calculated based on a percentage made up by each category of a total number of categories (e.g., a reciprocal of the percentage made up by each category of a total number of categories). In this manner, a higher importance may be assigned to a rarer category (a category to which a fewer items belong) than other categories. Even if the characteristic values are based on other scales (e.g., an ordinal scale, an interval scale, and a proportional scale), it is possible to assign an importance in view of the properties of the scales.

In other words, the importance calculation unit 120 is capable of calculating an importance no matter whether the incidental data is a quantitative variable (a variable expressed on an interval scale or a proportional scale) or a qualitative variable (a variable expressed on a nominal scale or an ordinal scale). If, for example, the incidental data is a quantitative variable, the importance calculation unit 120 may calculate an importance based on a statistical value of the incidental data. If, for example, the incidental data is a qualitative variable, the importance calculation unit 120 may calculate an importance based on a percentage made up by each category to which the incidental data belongs, of a total number of categories.

### Modification 4

In the above-described embodiment, a case has been described where the number of items of training data is constant regardless of the progression in training; however, the configuration is not limited thereto. For example, in Modification 4, the number of items of training data may be changed according to the progression in training. In the embodiment, to increase the training efficiency, the number of patch images generated from an SEM image that occurs infrequently but should be given an importance is adjusted. However, such an adjustment raises the risk of overfitting to a particular image pattern in accordance with advancement of the progression in training. To avoid such a risk, the training apparatus 100 may sharpen the contrast of importance (i.e., increase a variation in importance) at the initial progression in training, and weaken the contrast (i.e., decrease a variation in importance) with the advancement of training. In this manner, it is possible to perform balanced training that may avoid overfitting, while increasing the training efficiency. The progression in training may be defined based on the number of epochs, or may be defined based on a decrease in the loss.

Specifically, the importance calculation unit 120 may change the method of calculating an importance according to the progression in training. More specifically, the importance calculation unit 120 may change the calculation parameter (e.g., the value of σ in the formula (1)) of the calculation formula for calculating the importance, or change the calculation formula according to the progression in training. If the calculation formula is changed, for example, a calculation formula that causes a greater variation in importance may be used in the first half of the progression in training, and a calculation formula that causes a smaller variation in importance may be used in the latter half of the progression in training. In other words, the importance calculation unit 120 may calculate the importance in such a manner that a variation in importance among the plurality of items of subject data decreases as the progression in training advances.

### Modification 5

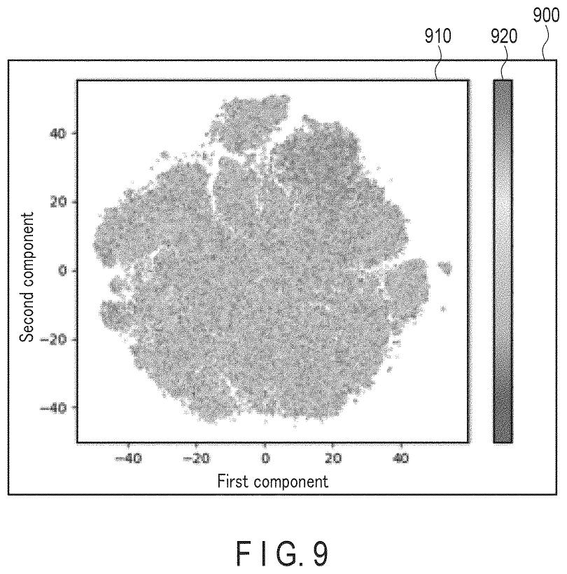

In the training apparatus according to the above-described embodiment, a case has been described where the display control unit 150 causes a correlation chart to be displayed as display data based on feature vectors; however, the configuration is not limited thereto. For example, in Modification 5, the display control unit 150 may reflect characteristic values on a correlation chart. Specifically, the display control unit 150 may color-code a correlation chart (scatter chart) based on characteristic values. A scatter chart in which characteristic values are reflected will be described with reference to FIG. 9.

FIG. 9 shows an example of display data including scatter charts in which characteristic values are reflected. Display data 900 in FIG. 9 contains a scatter chart 910 and a color scale 920. In the scatter chart 910, feature vectors are denoted by a first component and a second component, which are different from each other. Also, in the scatter chart 910, different characteristic values are shown by color shades for each of the coordinate points respectively denoting feature vectors. In the color scale 920, which corresponds to the colors of coordinate points of the scatter chart 910, characteristic values are expressed from low to high with color shades. By thus color-coding the scatter chart, it is possible to improve the visibility and interpretability.

### Modification 6

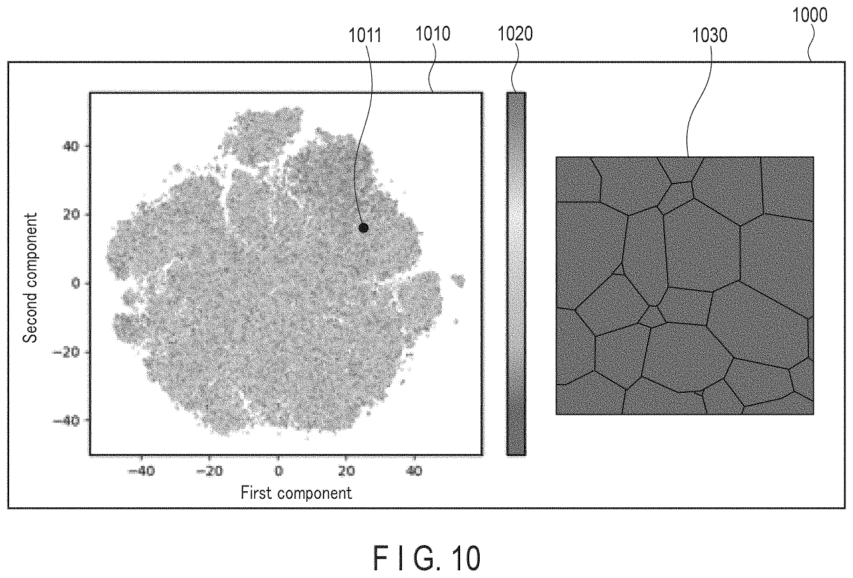

In Modification 5, a case has been described where the display control unit 150 causes a color-coded correlation chart to be displayed as display data; however, the configuration is not limited thereto. For example, in Modification 6, the display control unit 150 may cause a correlation chart (scatter chart) and training data (a patch image) corresponding to a coordinate point selected on the correlation chart to be displayed. Hereinafter, display of a patch image and a scatter chart in which characteristic values are reflected will be described with reference to FIG. 10.

FIG. 10 shows an example of display data including a patch image and a scatter chart in which characteristic values are reflected. Display data 1000 in FIG. 10 contains a scatter chart 1010, a color scale 1020, and a patch image 1030. In the scatter chart 1010, feature vectors are denoted by a first component and a second component, which are different from each other. Also, in the scatter chart 1010, different characteristic values are shown by color shades for each of the coordinate points respectively denoting feature vectors. In the color scale 1020, which corresponds to the colors of coordinate points of the scatter chart 1010, characteristic values are expressed from low to high with color shades. The patch image 1030 corresponds to a coordinate point 1011 selected on the scatter chart 1010. By thus displaying a patch image corresponding to a coordinate point on a scatter chart, it is possible to improve visibility and interpretability.

### Modification 7

In Modification 6, a case has been described where the display control unit 150 causes a correlation chart and a single item of training data to be displayed; however, the configuration is not limited thereto. For example, in Modification 7, the display control unit 150 may cause a correlation chart (scatter chart) and a plurality of items of training data (a patch image group) corresponding to a cluster including a coordinate point selected on the correlation chart to be displayed.

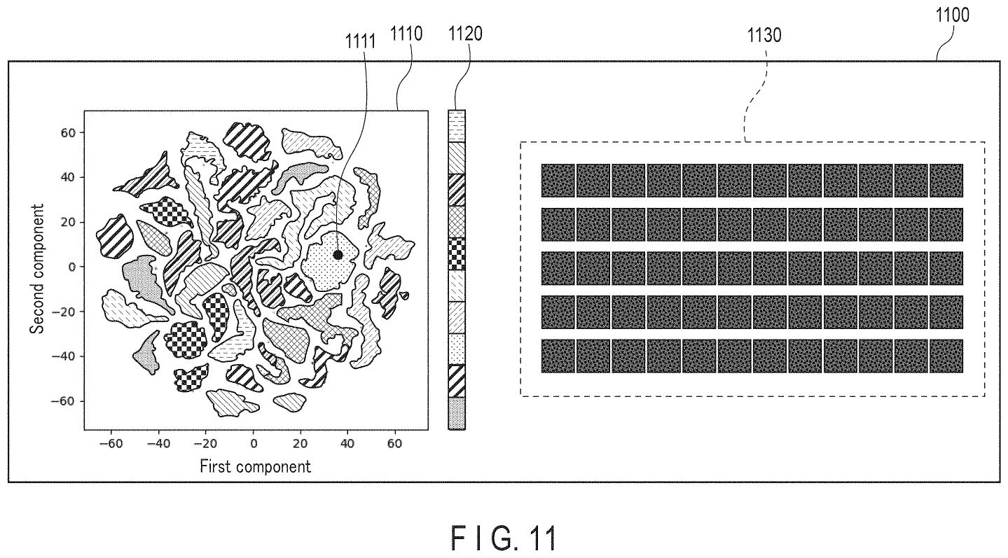

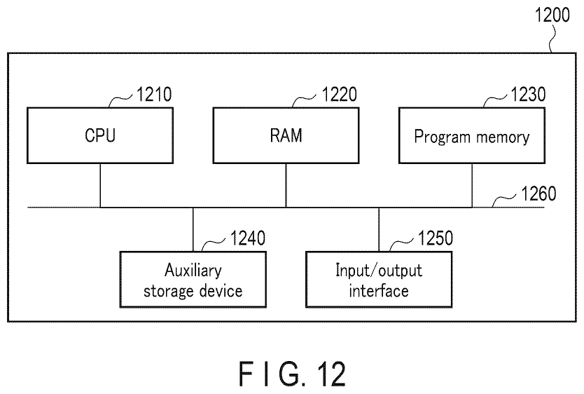

Furthermore, in Modification 7, the display control unit 150 may reflect feature cluster labels on a correlation chart. Specifically, the display control unit 150 may color-code a correlation chart (scatter chart) based on feature cluster labels. The feature cluster labels may be generated for a plurality of feature vectors using a cluster estimation technique. Examples of the cluster estimation technique include the elbow method, silhouette analysis, and density-based spatial clustering of applications with noise (DBSCAN). Hereinafter, display of a patch image group and a scatter chart in which feature cluster labels are reflected will be described with reference to FIG. 11.

FIG. 11 shows an example of display data including a patch image group and a scatter chart in which feature cluster labels are reflected. Display data 1100 in FIG. 11 contains a scatter chart 1110, a color scale 1120, and a patch image group 1130. In the scatter chart 1110, feature vectors are denoted by a first component and a second component, which are different from each other. Also, in the scatter chart 1110, feature cluster labels for coordinate points respectively denoting the feature vectors are shown by different colors. In the color scale 1120, which corresponds to the colors of the coordinate points in the scatter chart 1110, feature cluster labels are expressed by the color. The patch image group 1130 corresponds to a cluster including a coordinate point 1111 selected on the scatter chart 1110. By thus displaying a patch image group corresponding to a cluster including a coordinate point on a scatter chart, it is possible to improve visibility and interpretability.

### Modification 8

In the above-described embodiment, a case has been described where an SEM image and characteristic values are used as specific examples of the subject data and the incidental data; however, the configuration is not limited thereto. For example, in Modification 1, as specific examples of the subject data and the incidental data, (1) an image of a leaf and a state of the leaf (2), a medical image and diagnostic information, (3) a photograph and information on a location of photography, (4) sound data and information at the time of sound collection, and (5) sensor data and information at the time of acquisition, for example, may be used.

In the specific example (1), an image of a leaf is used as the subject data, and a state of the leaf is used as the incidental data. The image of the leaf is, for example, an image obtained by photographing a single leaf with a camera. The image of the leaf may also be obtained by extracting a single leaf from a photographed image of a plurality of leaves. The state of the leaf is, for example, a presence or absence of a disease and a stage of advancement of the disease. Thus, the training apparatus according to Modification 8 is also applicable to the field of agriculture and forestry.

In the specific example (2), a medical image is used as the subject data, and diagnostic information is used as the incidental data. The medical image is, for example, a photography image acquired by an image diagnosis apparatus, etc., and a pathological image obtained by photographing a sample produced from a human tissue. The diagnostic information is, for example, a presence or absence of a disease, a stage of advancement of the disease, and prognostic information. Thus, the training apparatus according to Modification 8 is also applicable to the medical field.

In the specific example (3), a photograph is used as the subject data, and information on a location of photography is used as the incidental data. The photograph is, for example, an aerial photograph. The information on the location of photography is, for example, a population density and a seismic intensity (or a magnitude) at the time of occurrence of an earthquake. Thus, the training apparatus according to Modification 8 is also applicable to the field of disaster prevention.

In the specific example (4), sound data is used as the subject data, and information at the time of sound collection is used as the incidental data. The sound data is, for example, sound data (or speech data) in a sports game. The information at the time of sound collection is, for example, information on the sports game (e.g., the number of spectators and the score). Thus, the training apparatus according to Modification 8 is also applicable to the field of sports.

In the specific example (5), sensor data is used as the subject data, and information at the time of acquisition is used as the incidental data. The sensor data is, for example, a combination of image data (RGB+time four-dimensional signal data) recorded by a drive recorder and data (one-dimensional signal data) obtained by an acceleration sensor. The information at the time of acquisition is, for example, a date and time when the sensor data has been recorded, weather information, and whether an accident has occurred. Thus, the training apparatus according to Modification 8 is also applicable to the field of automobiles.

As described above, the training apparatus according to Modification 8 is capable of using, as the subject data, not only an SEM image (two-dimensional signal data) but also N-dimensional signal data (N≥1) such as sound data (one-dimensional signal data) and recorded image data (four-dimensional signal data). Thereby, the training apparatus according to Modification 8 is applicable not only to the manufacturing field (an example of the combination of an SEM image and characteristic values) but also to various other fields.

### Other Modifications

In the above-described embodiment, DNN has been described as a specific example of the machine learning model; however, the configuration is not limited thereto. For example, the machine learning model may be a model based on multiple regression analysis, a support vector machine (SVM), or decision tree analysis.

In the above-described embodiment, SimCLR+FD has been described as a specific example of the loss function; however, the configuration is not limited thereto. For example, the loss function may be calculated by a technique including only the first temperature parameter. Specifically, as the technique including the first temperature parameter, instance discrimination (ID), MOCO, BYOL, etc., as well as SimCLR, may be used. Moreover, IDFD, Barlow Twins, etc., may be used as the loss function, as well as SimCLR+FD, which is a combination of the first technique and the second technique.

### (Hardware Configuration)

FIG. 12 is a block diagram illustrating a hardware configuration of a computer according to the embodiment. The computer 1200 includes, as hardware, a central processing unit (CPU) 1210, a random-access memory (RAM) 1220, a program memory 1230, an auxiliary storage device 1240, and an input/output interface 1250. The CPU 1210 communicates with the RAM 1220, the program memory 1230, the auxiliary storage device 1240, and the input/output interface 1250 via the bus 1260.

The CPU 1210 is an example of a general-purpose processor. The RAM 1220 is used as a working memory in the CPU 1210. The RAM 1220 includes a non-volatile memory such as synchronous dynamic random-access memory (SDRAM). The program memory 1230 stores various programs including a training program. As the program memory 1230, a read-only memory (ROM), part of the auxiliary storage device 1240, or a combination thereof, for example, is used. The auxiliary storage device 1240 stores data in a non-transitory manner. The auxiliary storage device 1240 includes a non-volatile memory such as an HDD or an SSD.

The input/output interface 1250 is an interface for connection or communication with another device. The input/output interface 1250 is used for, for example, connection or communication between the training apparatus 100 and an input device (input unit), an output device, and a server, which are not illustrated.

The programs stored in the program memory 1230 include computer-executable instructions. Upon execution by the CPU 1210, the programs (computer-executable instructions) cause the CPU 1210 to execute predetermined processing. For example, upon execution by the CPU 1210, the training programs cause the CPU 1210 to execute a series of processing described with reference to each component of the training apparatus 100.

The programs may be provided to the computer 1200 in a state of being stored in a computer-readable storage medium. In this case, the computer 1200 further includes a drive (not illustrated) configured to read data from the storage medium, and acquire programs from the storage medium. Examples of the storage medium include magnetic disks, optical disks (a CD-ROM, a CD-R, a DVD-ROM, a DVD-R, etc.), a magnetooptical disk (an MO), a semiconductor memory, etc. Moreover, programs may be stored in a server on a communication network, such that the computer 1200 downloads the programs from a server using the input/output interface 1250.

The processing described in the embodiment is not limited to execution of programs by a general-purpose hardware processor such as the CPU 1210, and may be performed by a dedicated hardware processor such as an application-specific integrated circuit (ASIC). The term “processing circuitry” or “processing unit” includes at least one general-purpose hardware processor, at least one dedicated hardware processor, or a combination of at least one general-purpose hardware processor and at least one dedicated hardware processor. In the example shown in FIG. 12, the CPU 1210, the RAM 1220, and the program memory 1230 correspond to the processing circuitry.

According to the above-described embodiment, it is possible to train a model efficiently.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A training apparatus, comprising processing circuitry configured to:
acquire a plurality of items of subject data and a plurality of items of incidental data corresponding to the plurality of items of subject data;
calculate an importance of each of the plurality of items of subject data based on a distribution of the plurality of items of incidental data;
determine, for each of the plurality of items of subject data, a number of items of training data according to the importance, and generate a plurality of items of training data corresponding to the determined number of items of training data; and
iteratively train a learning model on the plurality of items of training data for each of the plurality of items of subject data by unsupervised learning.

2. The training apparatus according to claim 1, wherein
the processing circuitry is further configured to calculate the importance to be high for an item of incidental data corresponding to an item of subject data that appears infrequently.

3. The training apparatus according to claim 1, wherein
the processing circuitry is further configured to calculate the importance to be inversely proportional to a frequency of classification of the plurality of items of incidental data.

4. The training apparatus according to claim 1, wherein
the processing circuitry is further configured to calculate the importance to be higher for an item of incidental data that is farther from a mean or a median of the distribution.

5. The training apparatus according to claim 1, wherein
the processing circuitry is further configured to determine the number of items of training data to be larger for an item of subject data with a higher importance.

6. The training apparatus according to claim 1, wherein
the distribution is a normal distribution, and the processing circuitry is further configured to calculate the importance based on a probability density function of the normal distribution.

7. The training apparatus according to claim 1, wherein
the processing circuitry is further configured to calculate a loss using a technique which yields a smaller loss as an error between a first feature vector and a second feature vector obtained from different items of subject data included in the plurality of items of subject data increases.

8. The training apparatus according to claim 1, wherein
the processing circuitry is further configured to cause a correlation chart expressing feature vectors by different components to be displayed.

9. The training apparatus according to claim 8, wherein
the processing circuitry is further configured to cause the correlation chart and an item of training data corresponding to a coordinate point selected on the correlation chart to be displayed.

10. The training apparatus according to claim 8, wherein
the processing circuitry is further configured to cause the correlation chart and a plurality of items of training data corresponding to a cluster including a coordinate point selected on the correlation chart to be displayed.

11. The training apparatus according to claim 1, wherein
the processing circuitry is further configured to:
acquire calculation resource information; and
adjust the number of items of training data based on the calculation resource information.

12. The training apparatus according to claim 1, wherein
the processing circuitry is further configured to change a method of calculating the importance according to a progression in training of the learning model.

13. The training apparatus according to claim 12, wherein
the processing circuitry is further configured to calculate the importance in such a manner that a variation in the importance among the plurality of items of subject data decreases as the progression in training advances.

14. The training apparatus according to claim 1, wherein
the processing circuitry is further configured, if each of the plurality of items of incidental data is a quantitative variable, to calculate the importance based on a statistical value of each of the plurality of items of incidental data.

15. The training apparatus according to claim 1, wherein
the processing circuitry is further configured, if each of the plurality of items of incidental data is a qualitative variable, to calculate the importance based on a percentage made up by a category to which each of the plurality of items of incidental data belongs, of a total number of categories.

16. The training apparatus according to claim 1, wherein
the unsupervised learning is contrastive learning, and the processing circuitry is further configured to generate the plurality of items of training data in such a manner that a plurality of items of partial data forming each of the plurality of items of subject data do not overlap one another.

17. The training apparatus according to claim 1, wherein
each of the plurality of items of subject data is an image obtained by photographing a cross section of a product, and each of the plurality of items of incidental data is a value representing a characteristic of the product.

18. A training method, comprising:
acquiring a plurality of items of subject data and a plurality of items of incidental data corresponding to the plurality of items of subject data;
calculating an importance of each of the plurality of items of subject data based on a distribution of the plurality of items of incidental data;
determining, for each of the plurality of items of subject data, a number of items of training data according to the importance, and generating a plurality of items of training data corresponding to the determined number of items of training data; and
iteratively training a learning model on a plurality of items of training data for each of the plurality of items of subject data by unsupervised learning.

19. A non-transitory computer-readable storage medium storing a program for causing a computer to execute processing comprising:
acquiring a plurality of items of subject data and a plurality of items of incidental data corresponding to the plurality of items of subject data;
calculating an importance of each of the plurality of items of subject data based on a distribution of the plurality of items of incidental data;
determining, for each of the plurality of items of subject data, a number of items of training data according to the importance, and generating a plurality of items of training data corresponding to the determined number of items of training data; and
iteratively training a learning model on a plurality of items of training data for each of the plurality of items of subject data by unsupervised learning.
